(19) United States
(12) Patent Application Publication
(10) Pub. No.: US 2026/0081370 A1
(43) Pub. Date: Mar. 19, 2026

(54) TERMINAL BLOCK

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasuhiro KUDO, Mie (JP); Daisuke HASHIMOTO, Mie (JP); Kentaro TACHI, Mie (JP); Tomoki ABE, Mie (JP); Yoshitomo TSUJII, Mie (JP)

(21) Appl. No.: 18/997,802

(22) PCT Filed: Jul. 18, 2023
(86) PCT No.: PCT/JP2023/026179

§ 371 Date: Dec. 7, 2025

(30) Foreign Application Priority Data
Aug. 1, 2022 (JP) 2022-122714
Apr. 5, 2023 (JP) 2023-061622

(51) Int. Cl. H01R 9/24

(52) U.S. Cl. CPC H01R 9/24

(57) ABSTRACT

The present disclosure provides a terminal block that can improve the surge resistance. A terminal block (1) according to an aspect of the present disclosure comprises: at least one busbar (3); a block body and a magnetic member (28). A load is connected to one end (3a) of opposing ends of the busbar (3). The block body (4) supports the busbar (3) and is fitted to an attachment destination (7) to be attached. The magnetic member (28) is provided to the block body (4) so as to enclose the busbar (3) from the surroundings in order to suppress partial discharging caused by a surge voltage generated by driving of the load.

### TECHNICAL FIELD

The present disclosure relates to a terminal block.

### BACKGROUND

Conventionally, a terminal block to be mounted on a case including a built-in rotating electric machine is known as disclosed in Patent Document 1. This terminal block includes a power connector for relaying power to the rotating electric machine. The power connector includes three power terminal boards crossing a pedestal part of the terminal block. In the case of use for vehicle, the rotating electric machine in the case is electrically connected to an inverter for controlling power of an in-vehicle battery through the terminal block.

### PRIOR ART DOCUMENT

### Patent Document

Patent Document 1: JP 2011-160619 A

### SUMMARY OF THE INVENTION

### Problems to be Solved

Since the inverter executes a waveform control at a high speed, a surge voltage is easily generated when the rotating electric machine is driven. At this time, partial discharge may be caused by the surge voltage, wherefore there has been a concern that the insulation deterioration of a winding wire of the rotating electric machine is caused.

The present disclosure aims to provide a terminal block capable of improving surge resistance.

### Means to Solve the Problem

A terminal block for solving the above problem is provided with one or a plurality of busbars, a load being connected to one end, out of both ends, of the busbar, a block body for supporting the busbar, the block body being mounted on a mounting destination, and a magnetic member provided in or on the block body to surround the busbar to suppress partial discharge due to a surge voltage generated by driving the load.

### Effect of the Invention

The present disclosure can improve surge resistance in a terminal block.

### BRIEF DESCRIPTION OF THE DRAWINGS

FIG. 1 is a perspective view of a terminal block when viewed from front in a first embodiment.

FIG. 2 is a perspective view of the terminal block when viewed from behind.

FIG. 3 is a section along III-III shown in FIG. 4.

FIG. 4 is a section along IV-IV shown in FIG. 3.

FIG. 5 is a perspective view of busbars having a magnetic member mounted thereon.

FIG. 6 is a perspective view showing how to mount the magnetic member on the busbars.

FIG. 7 is a section along VII-VII shown in FIG. 4.

FIG. 8 is a section of a terminal block according to a second embodiment.

FIG. 9 is a section along IX-IX shown in FIG. 8.

FIGS. 10A to 10D are diagrams showing an assembly process of the terminal block.

FIG. 11 is a section of a terminal block according to a third embodiment.

FIGS. 12A to 12C are diagrams showing an assembly process of the terminal block.

FIG. 13 is a section of a terminal block according to a fourth embodiment.

FIGS. 14A and 14B are diagrams showing an assembly process of the terminal block.

FIG. 15 is a front view of a terminal block in another example.

FIG. 16 is a perspective view of busbars having a magnetic member mounted thereon in still another example.

FIG. 17 is a schematic diagram showing busbars having a magnetic member mounted thereon in still another example.

FIG. 18 is a diagram showing a defect of a conventional shape according to still another example.

### DETAILED DESCRIPTION TO EXECUTE THE INVENTION

First, embodiments of the present disclosure are listed and described.
[1] The terminal block of the present disclosure is provided with one or a plurality of busbars, a load being connected to one end, out of both ends, of the busbar, a block body for supporting the busbar, the block body being mounted on a mounting destination, and a magnetic member provided in or on the block body to surround the busbar to suppress partial discharge due to a surge voltage generated by driving the load.

According to this configuration, since the magnetic member is arranged around the busbar, a noise current due to a surge voltage during the drive of the load can be absorbed by the magnetic member. Thus, the occurrence of partial discharge due to the surge voltage can be suppressed by the magnetic member. Therefore, surge resistance can be improved.
[2] In [1] described above, the magnetic member is formed in such a shape that the plurality of busbars are mountable therein. According to this configuration, since the plurality of busbars are mounted in the magnetic member, noise currents possibly generated in the respective busbars can be cancelled each other by the magnetic member. This further contribute to improving the surge resistance.
[3] In [2] described above, the magnetic member includes holes for each busbar, the busbar being inserted through the hole. According to this configuration, in which of the holes of the magnetic member the busbar should be set is easily understood.
[4] In [2] described above, the magnetic member includes one hole, the plurality of busbars being collectively insertable through the hole. According to this configuration, since the plurality of busbars can be collectively inserted through the hole of the magnetic member, the busbars are more easily set in the hole. Further, the magnetic member can have a one-piece structure, rather than a divided structure.
[5] In any one of [1] to [4] described above, the block body is a resin molding integrally formed with the busbar and the magnetic member. According to this configuration, the busbar, the block body and the magnetic member can be configured as one integrated component (assembly).
[6] In [5] described above, the block body includes an insulating portion formed by a resin having entered between the busbar and the magnetic member. According to this configuration, insulation between the busbar and the magnetic member can be ensured by the insulating portion.
[7] In [1] described above, the busbar and the block body constitute an integrated product as one component, and the magnetic member is formed to surround the integrated product. According to this configuration, since an inner diameter of the magnetic member can be suppressed as small as possible if the magnetic member is shaped to surround the busbar, a large impedance of the magnetic member can be set. Thus, the noise removal performance of the magnetic member can be enhanced.
[8] In [7] described above, the magnetic member is a strip-like magnetic foil wound around the integrated product a plurality of times. According to this configuration, the magnetic member can be formed by a simple method of winding the strip-like magnetic foil on the integrated product.
[9] In [7] described above, the block body is an insulating resin for insulating the busbar, and the magnetic member is a magnetic resin formed into a shape to surround the insulating resin and containing a magnetic powder. According to this configuration, an assembly including the magnetic member can be, for example, manufactured by a simple method such as insert molding using a resin.
[10] In [1] described above, the busbar includes an insulation layer on a surface, and the block body is a magnetic resin formed into a shape to surround the busbar and containing a magnetic powder. According to this configuration, since the block body itself contains the magnetic powder, the separate magnetic member needs not be mounted in or on the block body. Thus, the block body can be reduced in size.
[11] The insulation layer is an enamel layer. According to this configuration, a general-purpose busbar having a surface covered with an enamel layer can be used.
[12] In any one of [1] to [11] described above, a sealing portion is provided which seals between the busbar and the block body. According to this configuration, a gap between the busbar and the block body is sealed by the sealing portion. Thus, a situation where fluids and foreign matters intrude through the gap between the busbar and the block body can be made less likely to occur.
[13] In any one of [1] to [12] described above, the block body includes a mounting portion to be fixed to the mounting destination by a fastener, a first part extending toward the load from the mounting portion, and a second part extending in a direction opposite to the load from the mounting portion. According to this configuration, the block body can be mounted on the mounting destination by fixing the mounting portion to the mounting destination by the fastener.
[14] In [13] described above, the magnetic member is arranged in the first part. According to this configuration, even if the size of the second part is not sufficiently large and the magnetic member cannot be arranged in the second part due to the arrangement space of the terminal block, such a problem can be coped with by providing the magnetic member in the first part.
[15] In [13] described above, the magnetic member is arranged in the second part. According to this configuration, even if the size of the first part is not sufficiently large and the magnetic member cannot be arranged in the first part due to the arrangement space of the terminal block, such a problem can be coped with by providing the magnetic member in the second part.
[16] In [13] described above, a sealing portion is provided which seals between the busbar and the block body, and the sealing portion is arranged in the second part. According to this configuration, since the sealing portion can be arranged at a position distant from the load, a long distance can be set between the load and the sealing portion. Thus, fluids and foreign matters flowing out from the load are made less likely to reach the sealing portion. This is further advantageous in making a situation where the fluids and the foreign matters leak out from the sealing portion less likely to occur.
[17] In any one of [1] to [16] described above, three busbars of U-phase, V-phase and W-phase are provided, and three-phase alternating current signals having phases different from each other by 120° flow in the busbars. According to this configuration, since the three-phase alternating current signals phase-shifted from each other by 120° flow in the busbars, even if noise currents are generated in the three busbars, these easily cancel each other and become “0”. This further contributes to improving the surge resistance.
[18] In any one of [1] to [17] described above, the busbar includes a rod-like portion to be at least partially inserted into the block body and flat plate portions provided on both ends of the rod-like portion, the flat plate portions being worked into a flat plate shape as connection parts, and the magnetic member is provided to surround the rod-like portion. According to this configuration, since a part of the busbar is rod-like, the busbar can be reduced in diameter, for example, as compared to the case where the entire busbar is plate-like. This contributes to the size reduction of the terminal block.
[19] In any one of [1] to [18] described above, at least one of the plurality of busbars includes a bent portion bent to approach the adjacent busbar in a part surrounded by the magnetic member. According to this configuration, the busbars adjacent to each other can be brought as close as possible by the bent portion in the part surrounded by the magnetic member. Thus, the magnetic member can be reduced in size. This consequently contributes to the size reduction of the terminal block.

### Details of First Embodiment of Present Disclosure

A specific example of a terminal block 1 of the present disclosure is described below with reference to the drawings. Note that the present invention is not limited to these illustrations, but is represented by claims and includes all changes in the scope of claims and in the meaning and scope of equivalents. For the convenience of description, some components may be shown in an exaggerated or simplified manner in each drawing. Further, a dimension ratio of each part may be different from the actual one.

### (Summary of Terminal Block 1)

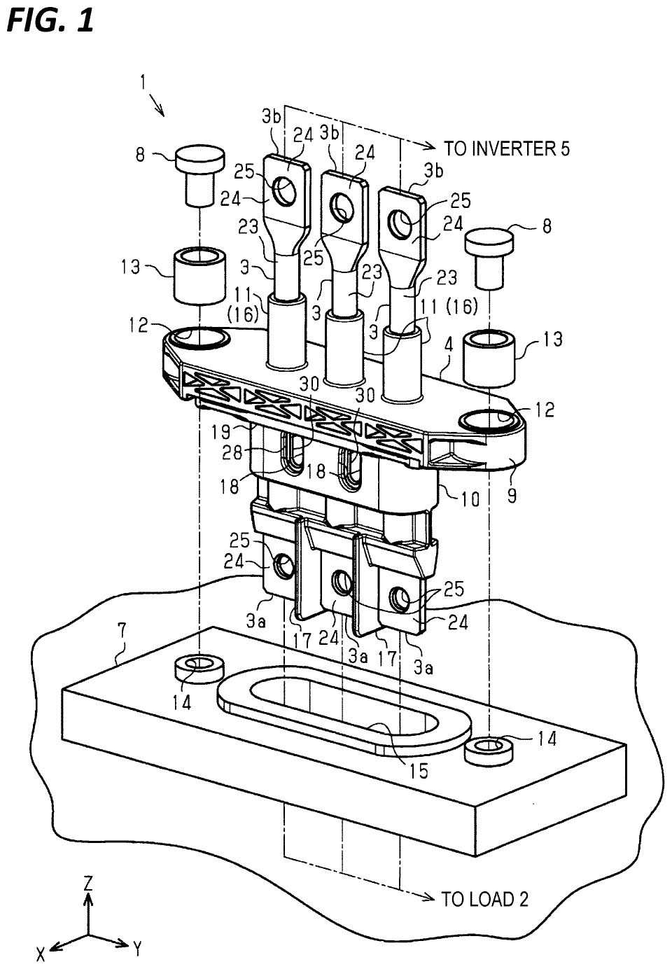

As shown in FIG. 1, the terminal block 1 is provided with one or a plurality of busbars 3 each having a load 2 connected to one end 3a, out of both sides, and a block body 4 for supporting the busbars 3. The load 2 is, for example, a motor and, in the case of this example, a three-phase alternating current motor. Three busbars 3 of U-phase, V-phase and W-phase are, for example, provided. Three-phase alternating current signals having phases different from each other by 120° flow in the busbars 3. Other ends 3b of the busbars 3 are connected to an inverter 5 for controlling a frequency of power to be supplied to the load 2. A high voltage and a large current necessary for the three-phase alternating current motor flow in the busbars 3.

The block body 4 is mounted on a mounting destination 7 by being fit. The mounting destination 7 is, for example, a case for accommodating the load 2. The block body 4 includes a mounting portion 9 to be fixed to the mounting destination 7 by fasteners 8, a first part 10 extending toward the load 2 from the mounting portion 9 and a second part 11 extending in a direction opposite to the load 2 from the mounting portion 9.

The mounting portion 9 is, for example, in the form of a flange. A total of two holes 12, through which the fasteners 8 are passed, are provided in both ends in a longitudinal direction (both ends in a Y-axis direction of FIG. 1) of the mounting portion 9. The block body 4 is mounted on the mounting destination 7 by fixing these fasteners 8 to recesses 14 of the mounting portion 9 while passing the fasteners 8 through collars 13 mounted in the holes 12. The fasteners 8 are, for example, bolts.

The first part 10 is in the form of a block (e.g. having a substantially rectangular parallelepiped shape), through which the plurality of busbars 3 are inserted. The first part 10 is fit into a recess 15 formed in the mounting destination 7 when the terminal block 1 is mounted on the mounting destination 7. The first part 10 is formed with walls 17 for insulating adjacent ones of the busbars 3 from each other. The first part 10 is formed with a plurality of (two in this example) holes 18, into which positioning pins (not shown) of a mold are inserted when the terminal block 1 is formed by the mold.

The second part 11 includes tube portions 16, through which one busbar 3 is inserted, for each busbar 3. In the case of this example, the second part 11 includes three tube portions 16.

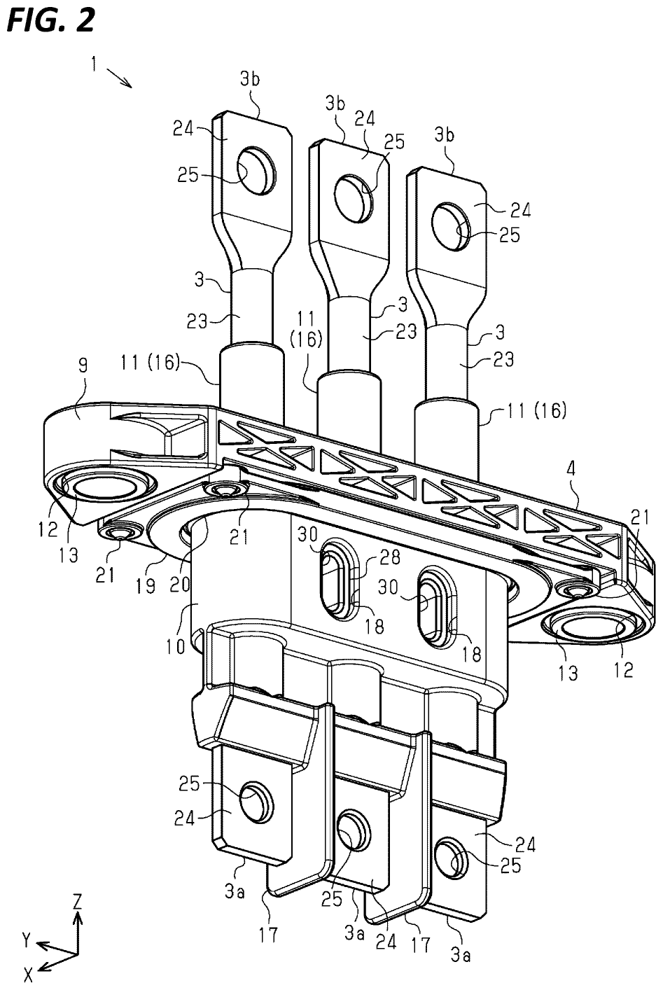

As shown in FIG. 2, the terminal block 1 includes a resilient member 19 for sealing between the block body 4 and the mounting portion 9. The resilient member 19 has, for example, an annular shape. The resilient member 19 is, for example, a rubber packing and an acrylic material, a silicon material or the like is used. The resilient member 19 includes a hole 20, through which the block body 4 (first part 10) is passed. The resilient member 19 is fixed to the mounting portion 9, for example, by engaging a plurality of pins 21 formed on the underside of the mounting portion 9 with four corners.

### (Shape of Busbar 3)

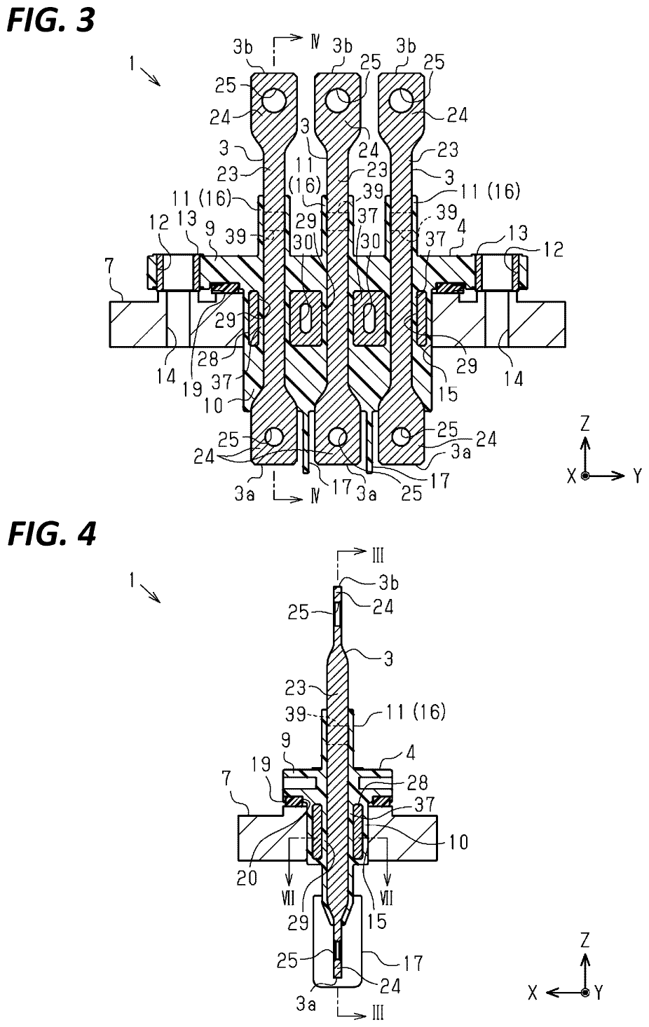

As shown in FIGS. 3 and 4, the busbar 3 includes a rod-like portion 23 to be at least partially inserted into the block body 4 and flat plate portions 24 worked into a flat plate shape as parts, to which a wire, a mating busbar (both not shown) or the like is connected. The rod-like portion 23 is, for example, formed into a cylindrical shape. The flat plate portions 24 are provided on both ends of the rod-like portion 23 and formed with a hole 25, through which a fastener (not shown) for fixing the wire is inserted. In the case of this example, the load 2 is electrically connected to one flat plate portion 24, and the inverter 5 is electrically connected to the other flat plate portion 24. The busbar 3 is, for example, made of copper or aluminum.

### (Summary of Magnetic Member 28)

As shown in FIGS. 3 and 4, the terminal block 1 is provided with a magnetic member 28 for suppressing partial discharge due to a surge voltage generated by driving the load 2. The magnetic member 28 is provided in the block body 4 to surround the busbars 3. The magnetic member 28 is formed into such a shape that the busbars 3 are mountable therein. The magnetic member 28 is, for example, a ferrite core.

As shown in FIGS. 3 to 5, the magnetic member 28 includes holes 29, though which the busbars 3 are inserted, for each busbar 3. In this example, three holes 29 are, for example, provided and arranged at equal intervals in a longitudinal direction (Y-axis direction in FIG. 3 and the like) of the magnetic member 28. The magnetic member 28 is provided to surround parts of the rod-like portions 23 of the busbars 3. The hole 29 is, for example, formed into a circular cross-sectional shape. The magnetic member 28 is formed with a plurality of (two in this example) holes 30, into which the positioning pins (not shown) of the mold are inserted when the terminal block 1 is formed by the mold.

As shown in FIG. 6, the magnetic member 28 is formed by combining two components. Specifically, the magnetic member 28 is mounted on the busbars 3 by sandwiching the busbars 3 by a first component 33 and a second component 34. Note that the first and second components 33, 34 are obtained by vertically halving the magnetic member 28 and have the same shape.

As shown in FIGS. 3 and 4, the block body 4 is a resin molding integrally formed with the busbars 3 and the magnetic member 28. Specifically, the busbars 3 and the magnetic member 28 are set in the mold, and a resin is poured into the mold and solidified after setting, whereby an assembly of the busbars 3, the block body 4 and the magnetic member 28 is manufactured. In this way, the integrated assembly of the busbars 3, the block body 4 and the magnetic member 28 is manufactured by resin molding.

(Insulation between Busbars and Magnetic Member 28)

As shown in FIGS. 3 and 4, the block body 4 includes an insulating portion 37 formed by the resin having entered between the busbars 3 and the magnetic member 28. The insulating portion 37 ensures electrical insulation between the busbars 3 and the magnetic member 28. In the case of this example, a diameter of the hole 29 is set to be larger than that of the busbar 3 (specifically, the rod-like portion 23). In this way, the insulating portion 37 is formed by the resin flowed into gaps between the busbars 3 and the magnetic member 28 during resin molding.

### (Summary of Sealing Portions 39)

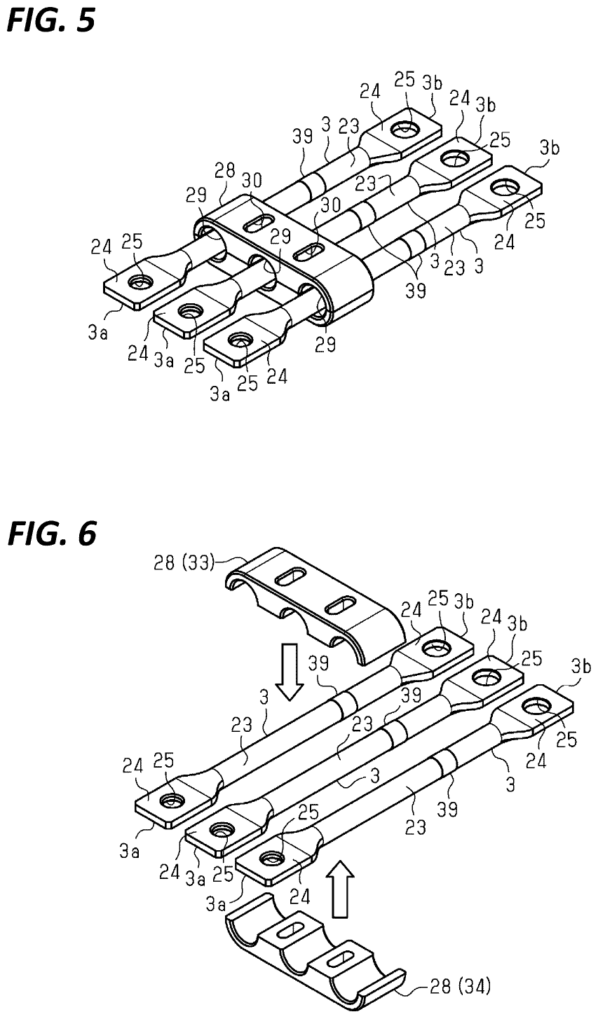

As shown in FIG. 5, the block body 1 is provided with sealing portions 39 for sealing between the busbars 3 and the block body 4. The sealing portion 39 is, for example, an adhesive (adhesive tape). The sealing portion 39 is, for example, annularly provided. The sealing portion 39 is, for example, between the busbar 3 and the tube portion 16. The sealing portion 39 ensures water sealability between the busbar 3 and the block body 4 and close contact to firmly fix the busbar 3 to the block body 4.

### (Arrangement Positions of Magnetic Member 28 and Sealing Portions 39)

As shown in FIGS. 3 and 4, the magnetic member 28 is, for example, arranged in the first part 10 of the block body 4. The sealing portions 39 are, for example, arranged in the second part 11 (tube portions 16) of the block body 4. As just described, in the case of this example, the magnetic member 28 and the sealing portions 39 are arranged at positions opposite to each other with respect to the mounting portion 9 of the block body 4.

### Functions of First Embodiment

Next, functions of this embodiment are described.

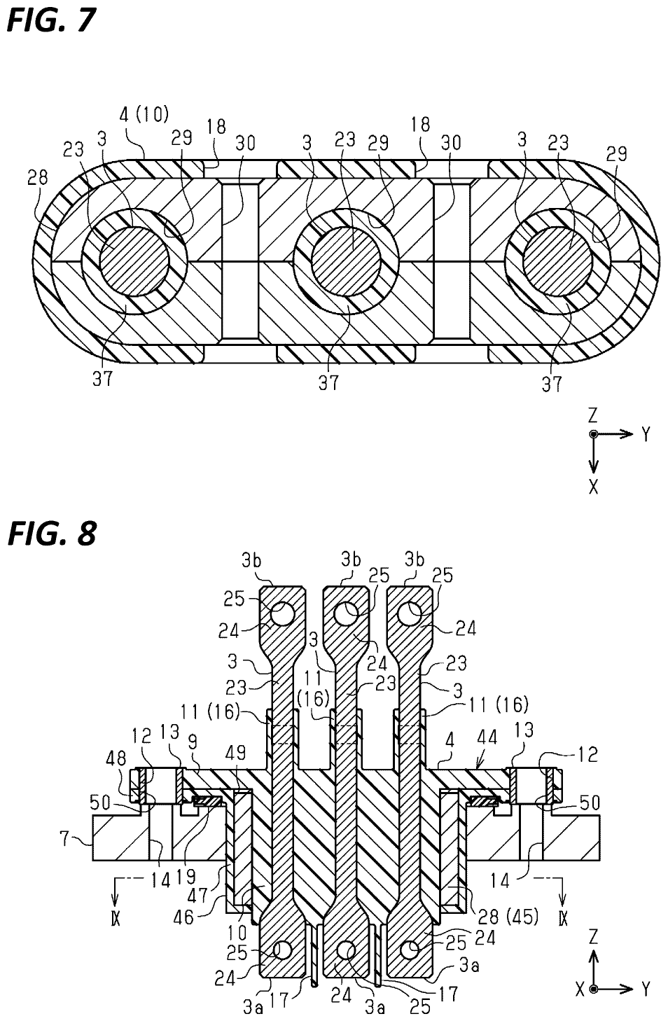

As shown in FIG. 7, the magnetic member 28 is structured to surround the busbars 3 (specifically, the rod-like portions 23). Thus, even if a surge voltage is generated by driving the load 2, noise currents generated due to the surge voltage can be absorbed by the magnetic member 28. In this way, partial discharge possibly occurring due to the surge voltage can be suppressed to be low by a magnetic shielding effect of the magnetic member 28. Thus, the surge resistance of the terminal block 1 can be improved. Consequently, the insulation deterioration of a winding wire of the load 2 can be made less likely to occur by improving the surge resistance.

Further, in the case of this example, three-phase alternating current signals of U-layer, V-layer and W-layer flow in the three busbars 3. Since the three busbars 3, in which the three-phase alternating current signals flow, are collectively covered by one magnetic member 28, noise currents of the three-phase alternating currents can cancel each other. Thus, if the three-phase alternating current signals flow in the three busbars 3, a high noise current absorbing effect can be realized if a measure is taken for surge resistance by the magnetic member 28 of this example.

As shown in FIGS. 3 and 4 and the like, the sealing portions 39 are provided to seal the gaps between the busbars 3 and the block body 4. Thus, even if fluids and foreign matters flow out from the load 2, these can be blocked by the sealing portions 39. Thus, the fluids and the foreign matters flowing out from the load 2 can be suppressed from flowing to the outside of the case. Further, since the sealing portions 39 are arranged in the second part 11, the sealing portions 39 can be as distant from the load 2 as possible. Thus, the fluids and the foreign matters flowing out from the load 2 can be made less likely to reach the sealing portions 39, wherefore a situation where the fluids and the foreign matters flow out from the sealing portions 39 can be made less likely to occur.

The busbar 3 is not plate-like (flat plate-like), but is formed into a shape including the rod-like portion 23. Thus, the busbar 3 can be reduced in diameter, for example, as compared to the case where the entire busbar is plate-like. Therefore, the magnetic member 28 and the terminal block 1 can be reduced in size.

### Effect of First Embodiment

According to the terminal block 1 of the above embodiment, the following effects can be obtained.
(1.1) The terminal block 1 is provided with one or the plurality of busbars 3, the block body 4 and the magnetic member 28. The load 2 is connected to the one end 3a, out of the both ends, of the busbar 3. The block body 4 supports the busbars 3 and is mounted on the mounting destination 7. The magnetic member 28 is mounted in the block body 4 to surround the busbars 3 to suppress partial discharge due to a surge voltage generated by driving the load 2.

According to this configuration, since the magnetic member 28 is arranged around the busbars 3, noise currents due to the surge voltage during the drive of the load can be absorbed by the magnetic member 28. Thus, the occurrence of partial discharge due to the surge voltage can be suppressed by the magnetic member 28. Therefore, surge resistance can be improved.
(1.2) The magnetic member 28 is formed into such a shape that the plurality of busbars 3 are mountable therein. According to this configuration, since the plurality of busbars 3 are mounted in one magnetic member 28, noise currents possibly generated in the respective busbars 3 can be canceled each other by the magnetic member 28. This further contributes to improving the surge resistance.
(1.3) The magnetic member 28 includes the holes 29, into which the busbars 3 are inserted, for each busbar 3. According to this configuration, in which of the holes 29 of the magnetic member 28 the busbar 3 has to be set is easily understood.
(1.4) The block body 4 is a resin molding integrally formed with the busbars 3 and the magnetic member 28. According to this configuration, the busbars 3, the block body 4 and the magnetic member 28 can be configured as one integrated component (assembly).
(1.5) The block body 4 includes the insulating portion 37 formed by the resin having entered between the busbars 3 and the magnetic member 28. According to this configuration, insulation between the busbars 3 and the magnetic member 28 can be ensured by the insulating portion 37.
(1.6) The terminal block 1 is provided with the sealing portions 39 for sealing between the busbars 3 and the block body 4. According to this configuration, the gaps between the busbars 3 and the block body 4 are sealed by the sealing portions 39. Thus, a situation where fluids and foreign matters intrude through the gaps between the busbars 3 and the block body 4 can be made less likely to occur.
(1.7) The block body 4 includes the mounting portion 9 to be fixed to the mounting destination 7 by the fasteners 8, the first part 10 extending toward the load 2 from the mounting portion 9 and the second part 11 extending in the direction opposite to the load 2 from the mounting portion 9. According to this configuration, the block body 4 can be mounted on the mounting destination 7 by fixing the mounting portion 9 to the mounting destination 7 by the fasteners 8.
(1.8) The magnetic member 28 is arranged in the first part 10. According to this configuration, even if the size of the second part 11 is not sufficiently large and the magnetic member 28 cannot be arranged in the second part 11 due to the arrangement space of the terminal block 1, such a problem can be coped with by providing the magnetic member 28 in the first part 10.
(1.9) The sealing portions 39 are arranged in the second part 11. According to this configuration, since the sealing portions 39 can be arranged at positions distant from the load 2, a long distance can be set between the load 2 and the sealing portions 39. Thus, fluids (e.g. motor oil and the like) and foreign matters flowing out from the load are made less likely to reach the sealing portions 39. This is further advantageous in making a situation where the fluids and the foreign matters leak out from the sealing portions 39 less likely to occur.
(1.10) The three busbars 3 of U-phase, V-phase and W-phase are provided. Three-phase alternating current signals having phases different from each other by 120° flow in the busbars 3. According to this configuration, since the three-phase alternating current signals phase-shifted from each other by 120° flow in the busbars 3, even if noise currents are generated in the three busbars 3, these easily cancel each other and become “0”. This further contributes to improving the surge resistance.
(1.11) The busbar 3 includes the rod-like portion 23 and the flat plate portions 24. The rod-like portion 23 is at least partially inserted into the block body 4. The flat plate portions 24 are provided on the both ends of the rod-like portion 23 and worked into a flat plate shape as connection parts. The magnetic member 28 is provided to surround the rod-like portion 23. According to this configuration, since a part of the busbar 3 is rod-like, the busbar 3 can be reduced in diameter, for example, as compared to the case where the entire busbar is plate-like. This contributes to the size reduction of the terminal block 1.

### Second Embodiment

Next, a second embodiment is described. Note that the magnetic member 28 of the first embodiment is changed to another component in the second embodiment. Thus, the same parts as in the first embodiment are denoted by the same reference signs and not described, and only different parts are described in detail.

### (Structure of Terminal Block 1)

As shown in FIG. 8, busbars 3 and a block body 4 constitute an integrated product 44 as one component. In the case of this example, the integrated product 44 is, for example, formed by insert molding using a resin. Specifically, the integrated product 44 is formed by insert molding of setting the busbars 3 in a mold and filling the resin. In the case of this example, the block body 4 is a resin molding. Note that the integrated product 44 may be formed by a method other than insert molding.

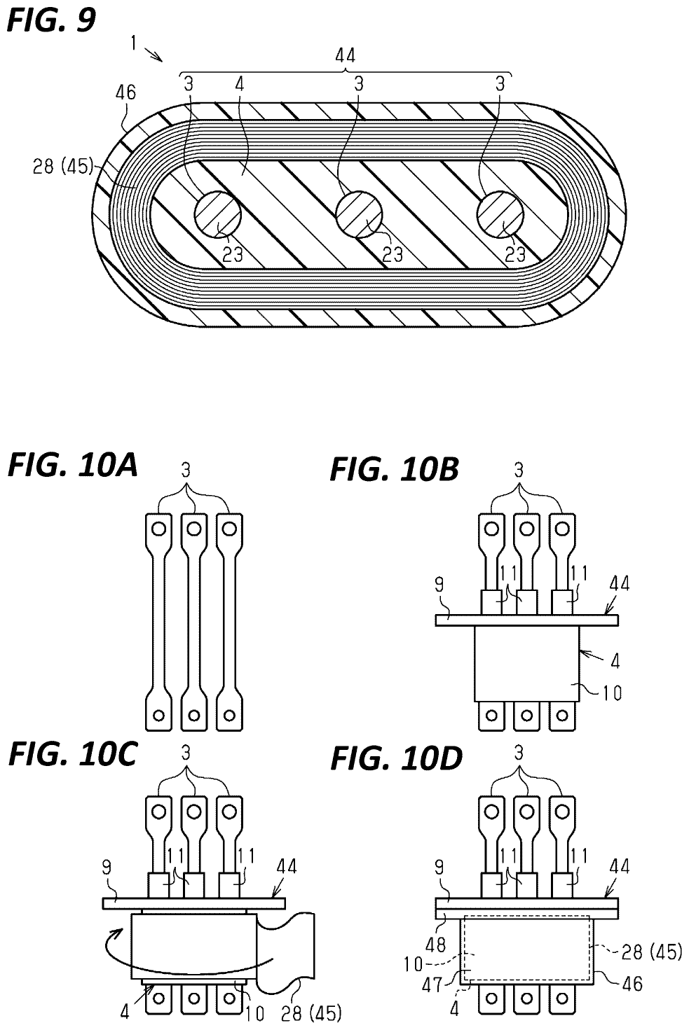

As shown in FIG. 9, a magnetic member 28 is formed to surround the integrated product 44. In the case of this example, the magnetic member 28 is a strip-like magnetic foil 45 wound around the integrated product 44 a plurality of times. In this way, the magnetic member 28 is formed by winding the strip-like magnetic foil 45 around the integrated product 44. The magnetic foil 45 is, for example, wound on the outer surface of a first part 10 of the block body 4. The wound magnetic foil 45 is formed into a substantially tubular shape. The substantially tubular magnetic foil 45 is formed into a flat elliptical shape when viewed from an axial direction. Permalloy, nickel, supermalloy, iron, ferrite, a combination of two or more of these or the like can be used as a material of the magnetic foil 45.

As shown in FIG. 8, the terminal block 1 is provided with a cover 46 for protecting the magnetic foil 45. The cover 46 includes a cover body 47 for covering the magnetic foil 45 and a flange portion 48 extending in a direction intersecting the cover body 47. The flange portion 48 is formed over the entire periphery of an opening 49 of the cover body 47. The flange portion 48 includes a plurality of holes 50, into which collars 13 are passed. A resilient member 19 is arranged between a mounting destination 7 and the flange portion 48.

### Functions of Second Embodiment

Next, functions of the terminal block 1 of this embodiment are described.

As shown in FIG. 10A, three-phase busbars 3 used in each of U-phase, V-phase and W-phase are prepared in the case of manufacturing the terminal block 1. As shown in FIG. 10B, the integrated product 44 integrated with the busbars 3 and the block body 4 is manufactured by insert molding of setting these busbars 3 in the mold and filling the resin. The three busbars 3 are electrically insulated by the block body 4 made of resin and formed by insert molding.

Subsequently, as shown in FIG. 10C, the strip-like magnetic foil 45 is wound on the outer surface of the integrated product 44 a plurality of times. A combination of a thickness, a winding number, the material and the like of the magnetic foil 45 is set as appropriate according to a required degree of noise absorption. Further, an adhesive may be applied to the surface of the magnetic foil 45. In this case, the overlapped parts of the magnetic foil 45 can be fixed to each other, wherefore unintended detachment of the magnetic foil 45 is suppressed.

As shown in FIG. 10D, the cover 46 is mounted on the integrated product 44 having the magnetic foil 45 wound therearound. The cover 46 is mounted to surround the magnetic foil 45. In the above way, the terminal block 1 is assembled.

### Effects of Second Embodiment

According to the terminal block 1 of this embodiment, the following effects can be obtained in addition to the effects described in the above embodiment.
(2.1) The busbars 3 and the block body 4 constitute the integrated product 44 as one component. The magnetic member 28 (magnetic foil 45 in this example) is formed to surround the integrated product 44. According to this configuration, if the magnetic member 28 is shaped to surround the busbars 3, an inner diameter of the magnetic member 28 can be suppressed as small as possible, wherefore a large impedance of the magnetic member 28 can be set. Thus, the noise removal performance of the magnetic member 28 can be enhanced.
(2.2) The magnetic member 28 is the strip-like magnetic foil 45 wound around the integrated product 44 a plurality of times. According to this configuration, the magnetic member 28 can be formed by a simple method of winding the strip-like magnetic foil 45 on the integrated product 44.

### Third Embodiment

Next, a third embodiment is described. Note that only parts different from the first and second embodiments are described in detail also in the third embodiment.

### (Structure of Terminal Block 1)

As shown in FIG. 11, a block body 4 is an insulating resin 53 for insulating busbars 3. The busbar 3 and the insulating resin 53 are, for example, formed by insert molding using a resin. Specifically, the busbars 3 and the insulating resin 53 are formed as an integrated product 44 by insert molding of setting the busbars 3 in a mold and filling the resin. In the case of this example, the insulating resin 53 is a resin molding.

A magnetic member 28 is a magnetic resin 55 shaped to surround the insulating resin 53 and containing a magnetic powder 54. The magnetic resin 55 is, for example, formed on a main part of the insulating resin 53, i.e. on the outer surface of a first part 10. The magnetic resin 55 is, for example, formed into a substantially tubular shape. Further, the substantially tubular magnetic resin 55 is formed into a flat elliptical shape when viewed from an axial direction. Permalloy, nickel, supermalloy, iron, ferrite, a combination of two or more of these or the like can be used as a material of the magnetic powder 54. The insulating resin 53 and the magnetic resin 55 may be, for example, formed by insert molding or may be formed by a method other than that.

### Functions of Third Embodiment

Next, functions of the terminal block 1 of this embodiment are described.

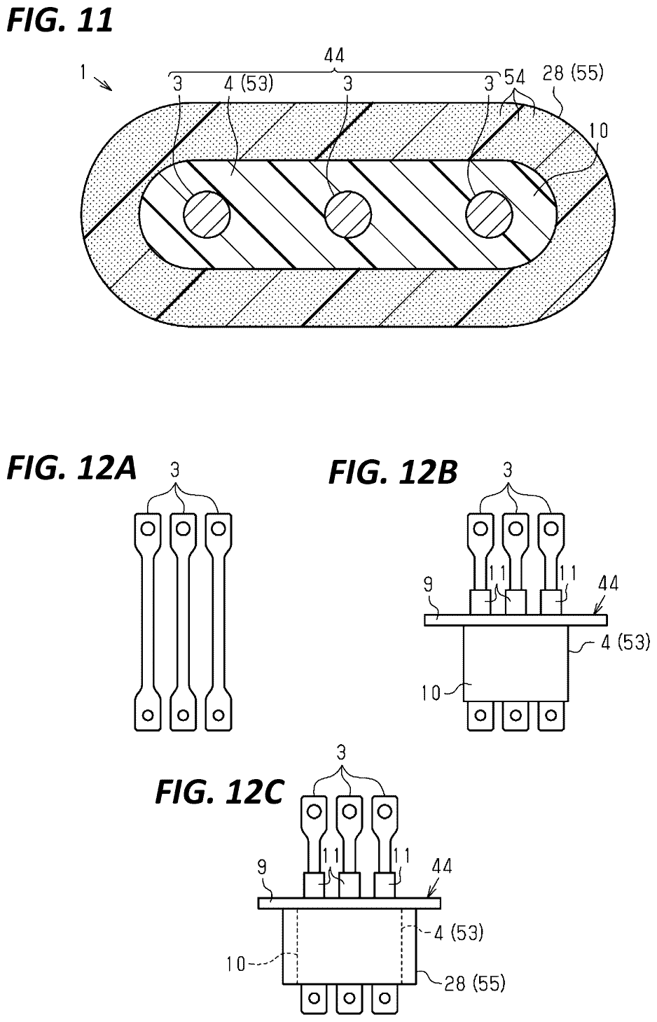

As shown in FIG. 12A, the three-phase busbars 3 used in each of U-phase, V-phase and W-phase are prepared in the case of manufacturing the terminal block 1. As shown in FIG. 12B, the integrated product 44 integrated with the busbars 3 and the insulating resin 53 is manufactured by insert molding of setting these busbars 3 in a mold and filling the resin. The three busbars 3 are electrically insulated by the insulating resin 53 formed by insert molding.

Subsequently, as shown in FIG. 12C, the magnetic resin 55 is molded on the integrated product 44 integrated with the busbars 3 and the insulating resin 53 by insert molding. Specifically, the integrated product 44 is set in a mold and an assembly integrated with the magnetic resin 55 is formed by filling a resin containing the magnetic powder 54 into the mold. In this way, the assembly in which the integrated product 44 is surrounded by the magnetic resin 55 is manufactured.

### Effects of Third Embodiment

According to the terminal block 1 of this embodiment, the following effect can be obtained in addition to the effects described in the above embodiments.
(3.1) The block body 4 is the insulating resin 53 for insulating the busbars 3. The magnetic member 28 is the magnetic resin 55 shaped to surround the insulating resin 53 and containing the magnetic powder 54. According to this configuration, the assembly including the magnetic member 28 can be, for example, manufactured by a simple method such as insert molding using a resin.

### Fourth Embodiment

Next, a fourth embodiment is described. Note that only parts different from the first to third embodiments are described in detail also in the fourth embodiment.

### (Structure of Terminal Block 1)

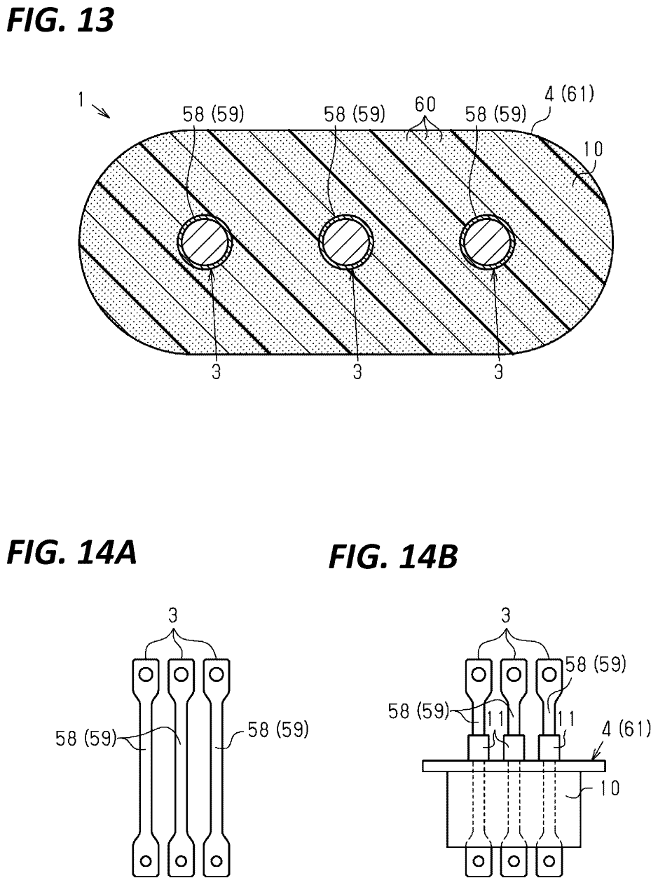

As shown in FIG. 13, a busbar 3 includes an insulation layer 58 on a surface. The insulation layer 58 is, for example, an enamel layer 59. The insulation layer 58 is, for example, formed over the entire surface of the busbar 3. Note that the insulation layer 58 is not limited to the enamel layer 59 and a tube such as a heat shrinkage tube, a resin tape or the like may be, for example, used.

The block body 4 is a magnetic resin 61 formed in a shape to surround the busbars 3 and containing a magnetic powder 60 serving as a magnetic member 28. As just described, the block body 4 of this example is the magnetic resin 61 containing the magnetic powder 60. A main part of the magnetic resin 61, i.e. a first part 10, is formed into a flat elliptical shape when viewed from an axial direction of the busbars 3. A material similar to that of the third embodiment is, for example, used as a material of the magnetic powder 60. The magnetic resin 61 may be, for example, formed by insert molding or may be formed by a method other than that.

### Functions of Fourth Embodiment

Next, functions of the terminal block 1 of this embodiment are described.

As shown in FIG. 14A, the busbars 3 of three phases (U-phase, V-phase, W-phase) each formed with the insulation layer 58 on the surface are prepared in the case of manufacturing the terminal block 1. As shown in FIG. 14B, an assembly integrated with the busbars 3 and the magnetic resin 61 is manufactured by insert molding of setting these busbars 3 in a mold and filling a resin containing the magnetic powder 60. The three busbars 3 are electrically insulated from the magnetic resin 61 by the insulation layers 58 on the surfaces.

### Effects of Fourth Embodiment

According to the terminal block 1 of this embodiment, the following effects can be obtained in addition to the effects described in the above embodiments.
(4.1) The busbar 3 includes the insulation layer 58 on the surface. The block body 4 is the magnetic resin 61 formed in a shape to surround the busbars 3 and containing the magnetic powder 60 serving as the magnetic member 28. According to this configuration, since the block body 4 itself contains the magnetic powder 60, the separate magnetic member 28 needs not be mounted in or on the block body 4. Thus, the block body 4 can be reduced in size.
(4.2) The insulation layer 58 is the enamel layer 59. According to this configuration, the general-purpose busbars 3 each having the surface covered by the enamel layer 59 can be used.

### Other Embodiments

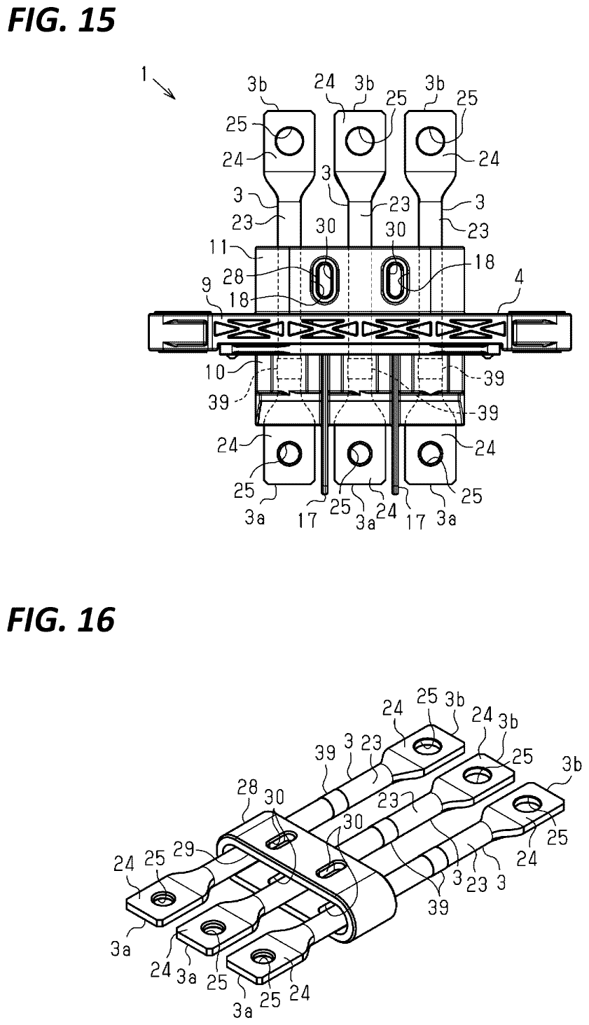

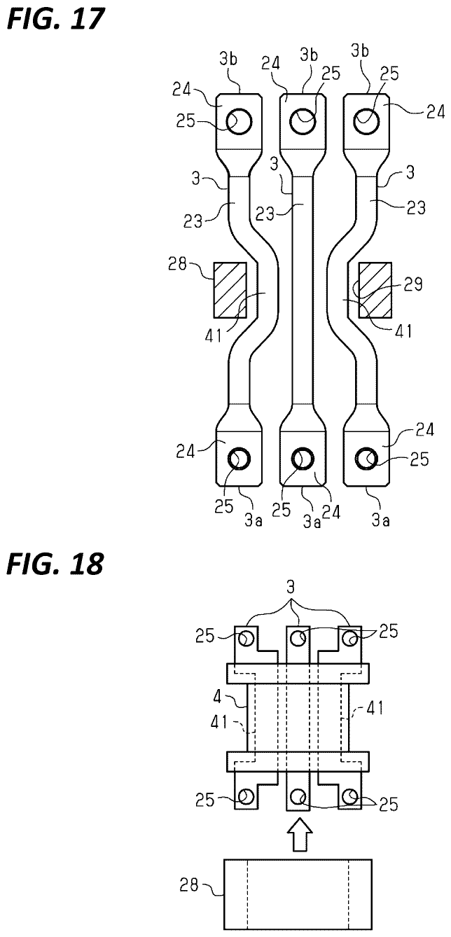

Note that these embodiments can be modified and carried out as follows. These embodiments and the following modifications can be carried out in combination without technically contradicting each other.
In the first and second embodiments, the magnetic member 28 may be, for example, arranged in the second part 11 instead of the first part 10 of the block body 4 as shown in FIG. 15. In this case, the second part 11 has a block shape and the magnetic member 28 is arranged in this second part 11. According to this configuration, even if the size of the first part 10 is not sufficiently large and the magnetic member 28 cannot be arranged in the first part 10 due to the arrangement space of the terminal block 1, such a problem can be coped with by providing the magnetic member 28 in the second part 11. Note that the sealing portions 39 are preferably provided in the first part 10 in the case of arranging the magnetic member 28 in the second part 11.
In the first embodiment, the hole 29, through which the busbars 3 are inserted, may be shaped to be able to collectively accommodate the plurality of busbars 3 as shown in FIG. 16. That is, the magnetic member 28 may include one hole 29, through which the plurality of busbars 3 are collectively insertable. The hole 29 in this case is, for example, a long hole when viewed from an axial direction of the hole 29. According to this configuration, since the plurality of busbars 3 can be collectively inserted through the hole 29 of the magnetic member 28, the busbars 3 are more easily set in the hole 29. Further, the magnetic member 28 can have a one-piece structure, rather than a divided structure.
In each embodiment, at least one of the plurality of busbars 3 may include a bent portion 41 bent to approach the adjacent busbar 3 in a part surrounded by the magnetic member 28 as shown in FIG. 17. In the case of an example of FIG. 17, the bent portions 41 are provided at halfway positions of the busbars 3 on both sides for the middle busbar 3. According to this configuration, the adjacent busbars 3 can be brought as close as possible by the bent portions 41 in the part surrounded by the magnetic member 28. Therefore, the magnetic member 28 can be reduced in size. Consequently, this further contributes to the size reduction of the terminal block 1.
In the second to fourth embodiments, in the case of using busbars 3 including bent portions 41 and a tubular magnetic member 28 as shown in FIG. 18, the magnetic member 28 interferes with end parts of the busbars 3 and cannot be inserted when being inserted into a block body 4 if an inner diameter of the magnetic member 28 is set to be as small as possible to provide the magnetic member 28 with high noise removal performance. However, if the magnetic member 28 is the magnetic foil 45 or the magnetic resin 55, 61, an operation of inserting the magnetic member 28 into the block body 4 is unnecessary, wherefore the inner diameter of the magnetic member 28 can be set to be as small as possible. Therefore, effects are high also in this point.
In the first embodiment, the magnetic member 28 is not limited to the shape for collectively covering the plurality of busbars 3. For example, one magnetic member 28 may be provided for each busbar 3.
In each embodiment, the magnetic member 28 is not limited to the ferrite core (made of ferrite) and may be a magnetic body such as a ferromagnetic body. The magnetic member 28 may be configured to consume or absorb noise currents in the busbars 3 near the busbars 3, for example, as iron losses or similar losses.
In each embodiment, the number of the busbars 3 is not limited to three, and may be two or less or four or more.
In each embodiment, in the case of providing the plurality of busbars 3, these busbars 3 are not limited to busbars having the same shape and at least one may have a different shape.
In the first and second embodiments, the assembly of the busbars 3, the block body 4 and the magnetic member 28 can be formed by a method other than insert molding. For example, the magnetic member 28 may be manually mounted on the assembly of the busbars 3 and the block body 4. In this way, the assembly may be formed by one of various methods.
In each embodiment, the shape of the rod-like portion 23 may be a polygonal column shape such as a rectangular column shape without being limited to the cylindrical shape.
In each embodiment, the insulating portion 37 may be, for example, a dedicated component separate from the block body 4 without being limited to a resin part as a part of the resin molding.
In each embodiment, the magnetic member 28 and the sealing portions 39 may be both provided in the first part 10 (may also be in the second part 11).
In each embodiment, the sealing portion 39 may be a sealing ring (rubber ring).
In each embodiment, the terminal block 1 may be, for example, shaped to include only the mounting portion 9 and the magnetic member 28 may be arranged in this mounting portion 9.
In each embodiment, the terminal block 1 may be, for example, shaped to include only the first part 10, and this first part 10 may be fixed to the mounting destination 7. Note that the same applies also to the second part 11.
In each embodiment, the signals flowing in the busbars 3 are not limited to the three-phase alternative current signals and may be signals other than these.
In each embodiment, the device to be connected to the other end 3b of the busbar 3 is not limited to the inverter 5 and may be, for example, another device such as a transformer.
In each embodiment, the load 2 is not limited to the motor and may be, for example, a resistance load, a solenoid, a lamp or the like.
In each embodiment, the terminal block 1 is not limited to that for vehicle and may be used in a machine or a device in another field.
In each embodiment, an expression “at least one” used in the present disclosure means “one or more” desired options. As an example, the expression “at least one” used in the present disclosure means “only one option” or “both of two options” if the number of options is two. As another example, the expression “at least one” used in the present disclosure means “only one option” or “a combination of two or more options” if the number of options is three.
Although the present disclosure has been described based on the examples in each embodiment, it is understood that the present disclosure is not limited to these examples and structures. The present disclosure also includes various modifications and modifications within the scope of equivalents. In addition, various combinations and forms, as well as other combinations and forms including only one element, more or less, are also within the scope and spirit of the present disclosure.
As shown in FIGS. 3 to 12C, the rod-like portion 23 of the busbar 3 may not include a non-metal insulation layer, which is possibly an enamel layer, on the surface thereof. The block body 4 of FIGS. 3 to 12C may not contain the magnetic powder. As shown in FIGS. 3 to 7, length parts of the rod-like portions 23 of the busbars 3 having no non-metal insulation layer and the entire magnetic member 28 may be embedded in the block body. As shown in FIGS. 8 to 12C, the magnetic member 28 (magnetic foil 45, magnetic resin 55) may be mounted on the outer surface of the block body 4 to surround length parts not containing the magnetic powder and embedded in the block body 4, out of the rod-like portions 23 of the busbar 3 having no non-metal insulation layer. As shown in FIGS. 13, 14A and 14B, the insulation layers 58 and the rod-like portions 23 of the busbars 3 may be embedded in the block body 4 containing the magnetic powder 60 serving as the magnetic member 28. This block body 4 may not be directly in contact with the rod-like portions 23 of the busbars 3 or may be directly in contact with the insulation layers 58.

The flat plate portions 24 and the rod-like portion 23 of the busbar 3 in the shown embodiments may be respectively referred to as flat plate-like electrical connection end parts and a non-flat plate-like intermediate rod. The block body 4 of the shown embodiments may be referred to as a busbar supporting block.
[Addendum 1] A terminal block according to several aspects of the present disclosure may be provided with a plurality of metal busbars, a busbar supporting block for fixedly supporting the plurality of metal busbars and a magnetic member for improving the surge resistance of the terminal block, each of the plurality of busbars may include two flat plate-like electrical connection end parts and a non-flat plate-like intermediate rod having a rod length and a rod thickness between the two flat plate-like electrical connection end parts, and the magnetic member may be fixed to the busbar supporting block at a position where the non-flat plate-like intermediate rod of each busbar can be surrounded at least over a part of the rod length.

According to the configuration of Addendum 1, the magnetic member can be positioned on the non-flat plate-like intermediate rod easily affected by a surge voltage, out of the entire length of each busbar. This is advantageous in combining a reduction in the influence on the surge voltage and a reduction in the rod thickness (conductor cross-sectional area) of the non-flat plate-like intermediate rod of the busbar. For example, this is advantageous in reducing a margin of the conductor cross-sectional area of the busbar in relation to a voltage.
[Addendum 2] In several aspects of the present disclosure, the entire member may be embedded in the busbar supporting block and may not be visible from the outside of the busbar supporting block.
[Addendum 3] In several aspects of the present disclosure, the magnetic member may be a foil to be wound on the busbar supporting block, and this foil may not be embedded in the busbar supporting block and may be visible from the outside of the busbar supporting block and, for example, may be exchangeable.
[Addendum 4] In several aspects of the present disclosure, the magnetic member may be a tube for accommodating a part of the busbar supporting block, and this tube may not be embedded in the busbar supporting block and may be visible from the outside of the busbar supporting block and, for example, may be exchangeable.

### LIST OF REFERENCE NUMERALS

1 terminal block
2 load
3 busbar
3a one end
3b other end
4 block body
5 inverter
7 mounting destination
8 fastener
9 mounting portion
10 first part
11 second part
12 hole
13 collar
14 recess
15 recess
16 tube portion
17 wall
18 hole
19 resilient member
20 hole
21 pin
23 rod-like portion
24 flat plate portion
25 hole
28 magnetic member
29 hole
30 hole
33 first component
34 second component
37 insulating portion
39 sealing portion
41 bent portion
44 integrated product
45 magnetic foil
46 cover
47 cover body
48 flange portion
49 opening
50 hole
53 insulating resin
54 magnetic powder
55 magnetic resin
58 insulation layer
59 enamel layer
60 magnetic powder
61 magnetic resin

1. A terminal block, comprising:
one or a plurality of busbars, a load being connected to one end, out of both ends, of the busbar;
a block body for supporting the busbar, the block body being mounted on a mounting destination; and
a magnetic member provided in or on the block body to surround the busbar to suppress partial discharge due to a surge voltage generated by driving the load,
the busbar including two flat plate-like electrical connection end parts on the both ends and a non-flat plate-like intermediate rod having a rod length and a rod thickness between the two flat plate-like electrical connection end parts, at least a part of the non-flat plate-like intermediate rod being inserted into the block body, and the magnetic member being fixed to the block body at a position capable surrounding at least a part of the rod length of the non-flat plate-like intermediate rod of the busbar.

2. The terminal block of claim 1, wherein the magnetic member is formed in such a shape that the plurality of busbars are mountable therein.

3. The terminal block of claim 2, wherein the magnetic member includes holes for each busbar, the busbar being inserted through the hole.

4. The terminal block of claim 2, wherein the magnetic member includes one hole, the plurality of busbars being collectively insertable through the hole.

5. The terminal block of claim 1, wherein the block body is a resin molding integrally formed with the busbar and the magnetic member.

6. The terminal block of claim 5, wherein the block body includes an insulating portion formed by a resin having entered between the busbar and the magnetic member.

7. The terminal block of claim 1, wherein:
the busbar and the block body constitute an integrated product as one component, and
the magnetic member is formed to surround the integrated product.

8. The terminal block of claim 7, wherein the magnetic member is a strip-like magnetic foil wound around the integrated product a plurality of times.

9. The terminal block of claim 7, wherein:
the block body is an insulating resin for insulating the busbar, and
the magnetic member is a magnetic resin formed into a shape to surround the insulating resin and containing a magnetic powder.

10. The terminal block of claim 1, wherein:
the busbar includes an insulation layer on a surface, and
the block body is a magnetic resin formed into a shape to surround the busbar and containing a magnetic powder.

11. The terminal block of claim 10, wherein the insulation layer is an enamel layer.

12. The terminal block of claim 1, comprising a sealing portion for sealing between the busbar and the block body.

13. The terminal block of claim 1, wherein the block body includes:
a mounting portion to be fixed to the mounting destination by a fastener;
a first part extending toward the load from the mounting portion; and
a second part extending in a direction opposite to the load from the mounting portion.

14. The terminal block of claim 13, wherein the magnetic member is arranged in the first part.

15. The terminal block of claim 13, wherein the magnetic member is arranged in the second part.

16. The terminal block of claim 13, comprising a sealing portion for sealing between the busbar and the block body,
wherein the sealing portion is arranged in the second part.

17. The terminal block of claim 1, wherein:
three busbars of U-phase, V-phase and W-phase are provided, and
three-phase alternating current signals having phases different from each other by 120° flow in the busbars.

18. The terminal block of claim 1, wherein at least one of the plurality of busbars includes a bent portion bent to approach the adjacent busbar in a part surrounded by the magnetic member.

19. (canceled)
